(19) United States
(12) Patent Application Publication
(10) Pub. No.: US 2021/0344291 A1
(43) Pub. Date: Nov. 4, 2021

(54) HYBRID SYNCHRONOUS CONDENSER AND POWER GENERATION UNIT

(71) Applicant: Siemens Energy, Inc., Orlando, FL (US)

(72) Inventors: Peter Jon Clayton, Casselberry, FL (US); Avinash Balbahadur, Orlando, FL (US)

(21) Appl. No.: 17/286,497

(22) PCT Filed: Oct. 24, 2018
(86) PCT No.: PCT/US2018/057281

§ 371 Date: Apr. 19, 2021

(51) Int. Cl. H02P 9/06; F01D 15/10; F02C 7/268; H02K 7/108; H02K 7/116; H02K 7/18; H02P 9/10

(52) U.S. Cl. CPC H02P 9/06; F01D 15/10; F02C 7/268; H02K 7/108; H02K 7/116; H02P 2101/25; H02P 9/105; F05D 2220/76; F05D 2220/32; F05D 2260/40; H02K 7/1823

(57) ABSTRACT

A hybrid power generation unit and synchronous condenser system connectable to a power grid includes a combustion turbine coupled to a first shaft and operable to provide rotational energy to the first shaft, a gear box coupled to the first shaft, and a first clutch portion coupled to the first shaft. A motor is selectively coupled to the gear box to turn the gear box and the first shaft, a second clutch portion is connected to a second shaft, and a generator is coupled to the second shaft. The generator is selectively connectable to the grid to operate as a synchronous condenser when the first clutch portion and the second clutch portion are disengaged and to convert rotational energy from the first shaft to electrical power when the first clutch portion and the second clutch portion are engaged.

### TECHNICAL FIELD

The present disclosure is directed, in general, to a power generation unit operable to generate electrical power and to operate as a synchronous condenser, and more specifically to such a unit arranged to improve the efficiency of the unit.

### BACKGROUND

Power generation and distribution includes the generation of real power and reactive power. Reactive power describes the background energy movement in an Alternating Current (AC) system arising from the production of electric and magnetic fields. These fields store energy which changes through each AC cycle. Devices which store energy by virtue of a magnetic field produced by a flow of current are said to absorb reactive power; those which store energy by virtue of electric fields are said to generate reactive power.

Power flows, both actual and potential (reactive), must be carefully controlled for a power system to operate within acceptable voltage limits. Reactive power flows can give rise to substantial voltage changes across the system, which means that it is necessary to maintain reactive power balances between sources of generation and points of demand on a zonal basis. Unlike system frequency, which is consistent throughout an interconnected system, voltages experienced at points across the system form a “voltage profile” which is uniquely related to local generation and demand at that instant and is also affected by the prevailing system network arrangements. Improperly regulated reactive power can lead to damage of equipment and can require increased sizing of conductors in equipment to carry both the real power and the reactive power.

### SUMMARY

A hybrid power generation unit and synchronous condenser system connectable to a power grid includes a combustion turbine coupled to a first shaft and operable to provide rotational energy to the first shaft, a gear box coupled to the first shaft, and a first clutch portion coupled to the first shaft. A motor is selectively coupled to the gear box to turn the gear box and the first shaft, a second clutch portion is connected to a second shaft, and a generator is coupled to the second shaft. The generator is selectively connectable to the grid to operate as a synchronous condenser when the first clutch portion and the second clutch portion are disengaged and to convert rotational energy from the first shaft to electrical power when the first clutch portion and the second clutch portion are engaged.

In another construction, a method of operating a hybrid power generation unit and synchronous condenser includes accelerating a generator to synchronize the generator with an electrical grid, varying an excitation voltage for the generator to vary the reactive power output of the generator, engaging a motor with a gear box to rotate the gear box, and accelerating a combustion turbine to a firing speed in response to rotation of the gear box. The method also includes firing the combustion turbine, accelerating the combustion turbine to the same speed as the generator, engaging a clutch between the combustion turbine and the generator such that the combustion turbine drives the generator, and outputting electrical power from the generator to the grid.

In another construction, a hybrid power generation unit and synchronous condenser system connectable to a power grid includes a first shaft, a combustion turbine coupled to the first shaft and operable to provide rotational energy to the first shaft, a second shaft colinear with the first shaft, and a generator coupled to the second shaft and electrically connectable to the power grid. A third shaft is spaced apart from the first shaft and the second shaft, a motor is connected to the third shaft and driven by a variable speed drive, a gear box is positioned to selectively couple the first shaft and the third shaft for rotation, and a clutch is positioned to selectively connect the first shaft and the second shaft.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this specification and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 is a schematic illustration of a prior art simple cycle gas turbine and synchronous condenser system.

FIG. 2 is a schematic illustration of a hybrid synchronous condenser and power generation system in a synchronous condenser mode of operation.

FIG. 3 is a schematic illustration of the system of FIG. 2 in a power generation start-up mode.

FIG. 4 is a schematic illustration of the system of FIG. 2 in a power generation mode of operation.

FIG. 5 is a schematic illustration of another hybrid synchronous condenser and power generation system in a power generation start-up mode of operation.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

Also, it should be understood that the words or phrases used herein should be construed broadly, unless expressly limited in some examples. For example, the terms “including,” “having,” and “comprising,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise. Terms “about” or “substantially” or like terms are intended to cover variations in a value that are within normal industry manufacturing tolerances for that dimension. If no industry standard as available a variation of 20 percent would fall within the meaning of these terms unless otherwise stated.

Utilities today devote considerable attention to managing voltage levels and reactive power (VAR) throughout the power transmission and distribution systems. Loads that contain capacitors and inductors, such as electric motors, pumps, compressors, and the power supplies in modern electronics put additional strain on the grid, as the reactive portion of these loads causes them to draw more current than an otherwise comparable resistive load (such as a light bulb) would draw for the same amount of real power (kilowatts) transferred. This extra current causes additional heat in system components, which wastes energy and reduces service lifetime. Uncorrected reactive power makes it harder to stabilize grid voltage and drives additional cost throughout the entire grid since each component (e.g., conductors, transformers, and generators) must be sized to carry the total power.

The more reactive power flowing on a line, the less “room” there is for real power, and the less efficient the transmission and/or distribution system will be. Thus, utilities and other power generators attempt to control, and preferably minimize the amount of reactive power on a given transmission line.

Devices such as capacitor banks and special transformers can be located at substations or on feeders to control reactive power or VARs. In addition, synchronous generators, or condensers can be used to control reactive power. By varying the excitation of the generator, the generator can be made to absorb reactive power (under-excited) or to supply reactive power (over-excited) to the system as may be required. Typically, an automatic voltage regulator is part of an exciter system that controls the generator excitation to maintain the voltage and power factor (ratio of real power to reactive power) as desired.

However, the growth of distributed generation, and particularly distributed generation from small generators such as wind and solar generation that typically cannot control the reactive power, and the reduction of large centralized generators have made the control of reactive power more difficult.

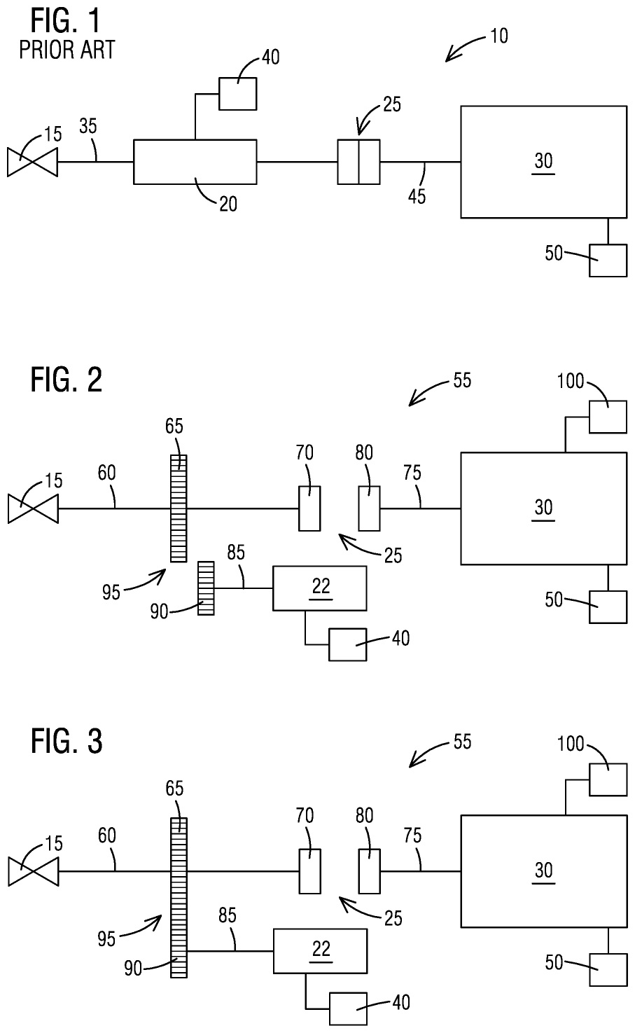

FIG. 1 illustrates a common power generation unit 10 that includes a prime mover in the form of a combustion turbine 15, a motor 20, a clutch 25 and an electrical generator 30 and that is operable to generate power and to operate as a synchronous condenser. The combustion turbine 15 is a simple cycle combustion turbine but could be part of a combined cycle system or other system arrangement. Arrangements such as this are often provided with new wind or solar generation to provide power at night or when the wind is calm. As is well known, the combustion turbine 15 includes a compressor section, a combustion section, and a turbine section. The compressor section and the turbine section are coupled to a first shaft 35 such that they rotate in unison. The compressor section draws in air and compresses the air for delivery to the combustion section. A portion of the compressed air is mixed with a flow of fuel and combusted to produce a flow of products of combustion that mix with the remaining compressed air. This mixture is then delivered to the turbine section where it is expanded to produce rotational energy to drive the compressor section and to provide additional rotational energy to the first shaft 35.

The motor 20 is coupled to the first shaft 35 to rotate in unison with the first shaft 35. In typical applications, a variable speed motor 20 such as a DC motor, a brushless DC motor, or an AC motor with a variable frequency drive 40 is used as the motor 20. In order to start or fire the turbine 15, the turbine 15 must be rotating at a firing speed. The firing speed is a speed that provides sufficient compressed air to the combustor section to sustain operation. The motor 20 is used to accelerate the turbine 15 to that firing speed to allow starting. Once the turbine 15 is started, the turbine 15 can accelerate to synchronous speed under its own power and the motor 20 is not needed.

The generator 30 is typically a multi-pole synchronous generator 30 that preferably includes two or more poles. The two-pole generator 30 operates at a synchronous speed of 3600 RPM to output three phase electrical power at 60 Hz. Of course, other speeds could be employed to generate power at a different frequency if desired. The generator 30 is supported for rotation on a second shaft 45 that is substantially colinear with the first shaft 35. As used herein, “substantially colinear” means that the shafts 35, 45 reside on a common curve for rotation. The common curve is not really a line due to the sag in the shafts 35, 45 due to the length of the shafts 35, 45 and the mass of the components.

A generator exciter system 50 provides power to the generator field as required to generate a rotating magnetic field for power generation. As discussed, power generation includes the generation of real power and reactive power. The exciter system 50 can be used to vary the power factor (the ratio of the real power to the reactive power) of the power generated by the generator 30. For example, the generator 30 can be made to absorb reactive power by under-exciting the field or to supply reactive power by over-exciting the field as may be desired.

The clutch 25 is positioned between the first shaft 35 and the second shaft 45 and allows for selective engagement and disengagement of the first shaft 35 and the second shaft 45. During the start-up of the combustion turbine 15, the clutch 25 is disengaged to allow the motor 20 to only accelerate the turbine 15, thereby allowing for a smaller, less expensive motor 20 than what would be required to simultaneously accelerate the turbine 15 and the generator 30.

FIG. 2 illustrates a power generation unit 55 having a different arrangement of the components of FIG. 1 that provides several construction, assembly, and maintenance advantages over the power generation unit 10 of FIG. 1. In the construction of FIG. 2, a first shaft 60 connects the turbine 15, a first portion of a gear box 65, and a first portion of a clutch 70. A second shaft 75 connects the generator 30 to a second portion of the clutch 80. The turbine 15 and the generator 30 operate substantially as described with regard to FIG. 1. The first portion of the clutch 70 and the second portion of the clutch 80 selectively engage one another to connect the first shaft 60 to the second shaft 75 with the first shaft 60 and the second shaft 75 being substantially colinear.

A third shaft 85 connects the motor 22 to a second portion of the gear box 90 and is disposed parallel to but spaced apart from the first shaft 60 and the second shaft 75. The first portion of the gear box 65 and the second portion of the gear box 90 define a gear box 95 which contains two or more gears arranged to provide a high mechanical advantage for the motor 22. The large mechanical advantage allows for the use of a smaller, reduced torque, high-speed motor 22 than what can be used in the arrangement of FIG. 1. The smaller motor 22 reduces the cost of the unit 55. In addition, the gear box 95 is preferably arranged to allow for the selective engagement and disengagement of the third shaft 85 from the first shaft 60. When disengaged, the turbine 15 does not have to provide energy to the motor 22 to rotate the motor 22 when not in use. This improves the operating efficiency of the unit 55 and reduces wear on the motor 22 and its supporting bearings.

The unit 55 of FIG. 2 is configurable in a synchronous condenser mode, a power generation mode, and a start-up mode which is really a transition state between the synchronous condenser mode and the power generation mode. FIG. 2 illustrates the unit 55 in the synchronous condenser mode in which the first portion of the gear box 65 is disconnected from the second portion of the gear box 90 and the first portion of the clutch 70 is disengaged from the second portion of the clutch 80 such that each of the first shaft 60, the second shaft 75, and the third shaft 85 are independent of one another. To operate in the synchronous condenser mode, a variable speed drive, pony motor, or other device 100 is used to accelerate the generator 30 to synchronous speed and synchronize the generator 30 to the utility grid or other grid. Once synchronized, the exciter 50 is used to either under excite or overexcite the generator field as required to control the reactive power on the grid to which the generator 30 is connected. The exciter 50 may include an automatic voltage regulator (AVR) which applies the appropriate excitation to the spinning generator 30 to control the reactive power produced by the generator 30.

Turning now to FIG. 3, the unit 55 is illustrated in the start-up mode. In this mode, the generator 30 may still be connected to the grid and rotating at synchronous speed (e.g., 3600 RPM). If the generator 30, and therefore the entire unit 55 is idle, the generator 30 can be started and synchronized as described with regard to FIG. 2. The first portion of the gear box 65 and the second portion of the gear box 90 are connected to interconnect the first shaft 60 and the third shaft 85. The motor 22 is then accelerated to a speed that corresponds to the firing speed of the turbine 15 and the turbine 15 is started.

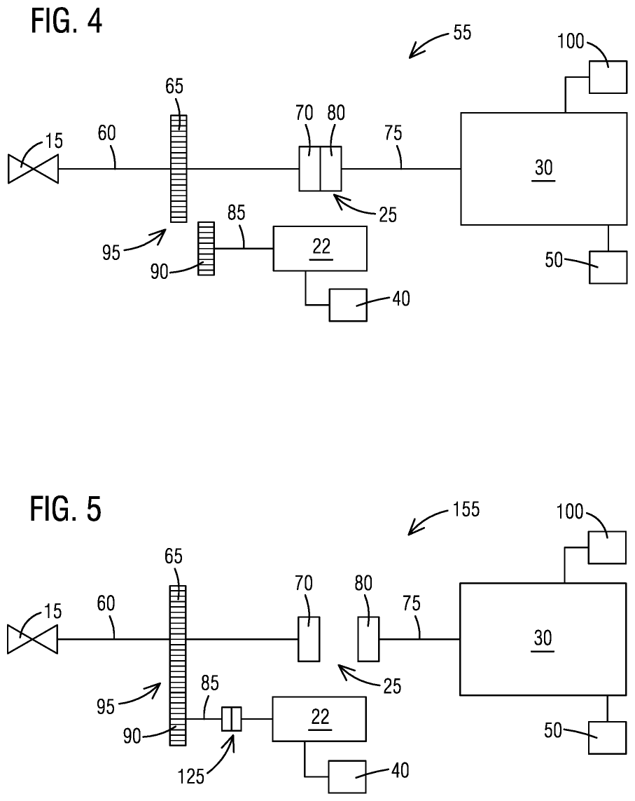

FIG. 4 illustrates the arrangement of the unit 55 during operation in the power generation mode. Once the turbine 15 is fired and the unit 55 is arranged as illustrated in FIG. 3, the gearbox 95 can be disconnected (as shown in FIG. 4) and the motor 22 returned to an idle state while the turbine 15 accelerates to synchronous speed. Once the turbine 15 matches the speed of the generator 30, the first portion of the clutch 70 and the second portion of the clutch 80 engage to couple the first shaft 60 and the second shaft 75. Excess rotational energy produced by the turbine 15 is now converted to electrical power by the generator 30 without the losses incurred by having to rotate the now idle motor 22.

The unit 55 illustrated in FIGS. 2-4 is advantageous in that it requires a shorter shaft arrangement which reduces alignment, plant cost and other maintenance concerns. The unit 55 also requires a smaller operating space as the overall footprint of the unit 55 is smaller than the unit 10. In addition, the motor 22 is not rotated during power generation mode or synchronous condenser mode, thereby allowing for more efficient operation and less maintenance for the motor 22 and associated hardware.

FIG. 5 illustrates another arrangement of a power generation unit 155 that is similar to the unit 55 illustrated in FIGS. 2-4. The unit 155 of FIG. 4 is illustrated in a power generation start-up mode like the unit 55 illustrated in FIG. 2. However, the unit 155 of FIG. 4 includes a second clutch 125 positioned between the portion of the gear box 90, or gear and the motor 22. The second clutch 125 allows for the selective engagement or disengagement of the motor 22 from the portion of the gear box 90 to allow the turbine 15 to run without turning the motor 22 and without having to disengage gears within the gear box 95.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A hybrid power generation unit and synchronous condenser system connectable to a power grid, the system comprising:
a combustion turbine coupled to a first shaft and operable to provide rotational energy to the first shaft;
a gear box coupled to the first shaft;
a first clutch portion coupled to the first shaft;
a motor selectively coupled to the gear box to turn the gear box and the first shaft;
a second clutch portion connected to a second shaft; and
a generator coupled to the second shaft, the generator selectively connectable to the grid to operate as a synchronous condenser when the first clutch portion and the second clutch portion are disengaged and to convert rotational energy from the first shaft to electrical power when the first clutch portion and the second clutch portion are engaged.

2. The power generation unit of claim 1, wherein the first shaft and the second shaft are substantially colinear.

3. The power generation unit of claim 2, wherein the motor rotates along an axis that is not colinear with the first shaft.

4. The power generation unit of claim 1, further comprising a generator excitation system operable to vary an excitation voltage for the generator when operating as a synchronous condenser to vary the reactive power output of the generator.

5. The power generation unit of claim 1, further comprising a variable speed drive operable to accelerate the generator to synchronous speed.

6. The power generation unit of claim 1, wherein the motor is a variable speed motor.

7. The power generation unit of claim 1, wherein the motor is supported on a third shaft that is parallel to and spaced apart from the first shaft.

8. The power generation unit of claim 1, wherein the motor is operable to accelerate the combustion turbine to a firing speed.

9. A method of operating a hybrid power generation unit and synchronous condenser, the method comprising:
accelerating a generator to synchronize the generator with an electrical grid;
varying an excitation voltage for the generator to vary the reactive power output of the generator;
engaging a motor with a gear box to rotate the gear box;
accelerating a combustion turbine to a firing speed in response to rotation of the gear box;
firing the combustion turbine;
accelerating the combustion turbine to the same speed as the generator;
engaging a clutch between the combustion turbine and the generator such that the combustion turbine drives the generator; and
outputting electrical power from the generator to the grid.

10. The method of claim 9, further comprising operating a variable frequency drive to accelerate the generator.

11. The method of claim 9, wherein the combustion turbine, the generator, and the clutch rotate on a common rotational axis.

12. The method of claim 9, further comprising a motor selectively operable to drive the combustion turbine.

13. The method of claim 12, wherein the combustion turbine rotates about a first axis and the motor rotates about a second axis separate from and parallel to the first axis.

14. The method of claim 12, wherein the accelerating the combustion turbine to the same speed as the generator step includes disengaging the motor from the gear box.

15. A hybrid power generation unit and synchronous condenser system connectable to a power grid, the unit comprising:
a first shaft;
a combustion turbine coupled to the first shaft and operable to provide rotational energy to the first shaft;
a second shaft colinear with the first shaft;
a generator coupled to the second shaft and electrically connectable to the power grid;
a third shaft spaced apart from the first shaft and the second shaft;
a motor connected to the third shaft and driven by a variable speed drive;
a gear box positioned to selectively couple the first shaft and the third shaft for rotation; and
a clutch positioned to selectively connect the first shaft and the second shaft.

16. The power generation unit of claim 15, wherein the system is operable in a synchronous condenser mode in which the gear box is disengaged such that the first shaft and the third shaft are not connected, and the clutch is disengaged such that the first shaft and the second shaft are not connected.

17. The power generation unit of claim 16, wherein the turbine is in an idle state during operation in the synchronous condenser mode.

18. The power generation unit of claim 16, further comprising a generator exciter system operable to vary a field voltage of the generator to control the reactive power of the generator when in the synchronous condenser mode.

19. The power generation unit of claim 15, wherein the system is operable in a power generation mode in which the gear box is disengaged such that the first shaft and the third shaft are not connected, and the clutch is engaged such that the first shaft and the second shaft are connected and the generator is operable to convert rotational power produced by the turbine to electrical power to be directed to the power grid.

20. The power generation unit of claim 15, wherein the system is operable in a start-up mode in which the gearbox is engaged such that the first shaft and the third shaft are connected, and the clutch is disengaged such that the first shaft and the second shaft are not connected and the motor is operable to accelerate the turbine to a firing speed.
